(19) United States
(12) Patent Application Publication
(10) Pub. No.: US 2025/0015297 A1
(43) Pub. Date: Jan. 9, 2025

(54) NEGATIVE ELECTRODE, METHOD OF MANUFACTURING THE SAME, AND BATTERY

(71) Applicants: MURATA MANUFACTURING CO., LTD., Kyoto (JP); TOKYO INSTITUTE OF TECHNOLOGY, Tokyo (JP)

(72) Inventors: Hideaki KUWAJIMA, Kyoto (JP); Keita IKEZAWA, Kyoto (JP); Yuki WATANABE, Kyoto (JP); Ryota SHIMIZU, Kyoto (JP); Taro HITOSUGI, Kyoto (JP)

(21) Appl. No.: 18/897,691

(22) Filed: Sep. 26, 2024

Related U.S. Application Data
(63) Continuation of application No. PCT/JP2023/010541, filed on Mar. 17, 2023.

(30) Foreign Application Priority Data
Mar. 31, 2022 (JP) 2022-059209

(51) Int. Cl. H01M 4/62; H01M 4/02; H01M 4/36; H01M 4/38; H01M 4/48; H01M 4/58; H01M 10/0562

(52) U.S. Cl. CPC H01M 4/628; H01M 4/366; H01M 4/382; H01M 4/48; H01M 4/5825; H01M 10/0562; H01M 2004/027; H01M 2300/0071

(57) ABSTRACT

A negative electrode includes an active material layer and an inorganic solid electrolyte layer. The inorganic solid electrolyte layer is on the active material layer. The active material layer includes, in order from a side far from the inorganic solid electrolyte layer, a lithium metal layer, an intermediate layer, and a surface layer. As constituent elements, the intermediate layer includes lithium and oxygen, the surface layer includes lithium, oxygen, and carbon, and the inorganic solid electrolyte layer includes a characteristic element different from lithium, oxygen, and carbon. In an element analysis result based on XPS, a ratio of an abundance of lithium to an abundance of carbon is greater than 2 at any depth within a range from a first intersection to a second intersection. The first intersection is where a characteristic element spectrum intersects a carbon spectrum. The second intersection is where a lithium spectrum intersects an oxygen spectrum.

### CROSS-REFERENCE TO RELATED APPLICATIONS

The present application is a continuation of PCT Application No. PCT/JP2023/010541, filed on Mar. 17, 2023, which claims priority to Japanese Patent Application No. 2022-059209, filed on Mar. 31, 2022, the entire contents of which are incorporated herein by reference.

### BACKGROUND

The present disclosure relates to a negative electrode, a method of manufacturing the same, and a battery.

Electrochemical devices such as batteries have been widely used. Such widespread use has promoted development of the electrochemical devices. Such an electrochemical device includes a positive electrode and a negative electrode, and a configuration of the negative electrode has been considered in various ways.

For example, in a process of forming the negative electrode, a surface of a lithium metal foil is subjected to an acid solution treatment, following which a solid electrolyte film is formed on the surface of the lithium metal foil.

As another approach, in a process of forming the negative electrode, a surface of a lithium metal foil is subjected to an etching process, following which a solid electrolyte film is formed on the surface of the lithium metal foil.

### SUMMARY

The present disclosure relates to a negative electrode, a method of manufacturing the same, and a battery.

A negative electrode according to an embodiment of the present disclosure includes an active material layer and an inorganic solid electrolyte layer. The inorganic solid electrolyte layer is provided on the active material layer. The active material layer includes, in order from a side far from the inorganic solid electrolyte layer, a lithium metal layer, an intermediate layer, and a surface layer. The intermediate layer includes lithium and oxygen as constituent elements. The surface layer includes lithium, oxygen, and carbon as constituent elements. The inorganic solid electrolyte layer includes, as a constituent element, a characteristic element different from lithium, oxygen, and carbon. In a result of an element analysis of the active material layer and the inorganic solid electrolyte layer in a depth direction based on X-ray photoelectron spectroscopy, a ratio of an abundance of lithium to an abundance of carbon is greater than 2 at any depth within a range from a first intersection to a second intersection. The first intersection is where a spectrum derived from the characteristic element and a spectrum derived from carbon intersect each other. The second intersection is where a spectrum derived from lithium and a spectrum derived from oxygen intersect each other.

A method of manufacturing a negative electrode according to an embodiment of the present disclosure includes: preparing a precursor in which a lithium metal layer, an intermediate layer, and a surface layer are stacked in this order, the intermediate layer including lithium and oxygen as constituent elements, the surface layer including lithium, oxygen, and carbon as constituent elements; forming an active material layer including the lithium metal layer, the intermediate layer, and the surface layer by subjecting the precursor to rolling in a reduced-pressure environment or an inert gas atmosphere; and forming an inorganic solid electrolyte layer on the surface layer of the active material layer in the reduced-pressure environment or the inert gas atmosphere.

A battery according to an embodiment of the present disclosure includes a positive electrode and a negative electrode. The negative electrode includes an active material layer and an inorganic solid electrolyte layer. The inorganic solid electrolyte layer is provided on the active material layer. The active material layer includes, in order from a side far from the inorganic solid electrolyte layer, a lithium metal layer, an intermediate layer, and a surface layer. The intermediate layer includes lithium and oxygen as constituent elements. The surface layer includes lithium, oxygen, and carbon as constituent elements. The inorganic solid electrolyte layer includes, as a constituent element, a characteristic element different from lithium, oxygen, and carbon.

In a result of an element analysis of the active material layer and the inorganic solid electrolyte layer in a depth direction based on X-ray photoelectron spectroscopy, a ratio of an abundance of lithium to an abundance of carbon is greater than 2 at any depth within a range from a first intersection to a second intersection. The first intersection is where a spectrum derived from the characteristic element and a spectrum derived from carbon intersect each other. The second intersection is where a spectrum derived from lithium and a spectrum derived from oxygen intersect each other.

### BRIEF DESCRIPTION OF THE FIGURES

The accompanying drawings are included to provide a further understanding of the present disclosure and are incorporated in and constitute a part of this specification. The drawings illustrate embodiments and, together with the specification, serve to explain the principles of the present disclosure.

FIG. 1 is a sectional diagram illustrating a configuration of a negative electrode according to embodimentan embodiment of the present disclosure.

FIG. 2 is a diagram schematically illustrating a result of an element analysis of a negative electrode (Example 1) in a depth direction based on X-ray photoelectron spectroscopy.

FIG. 3 is a sectional diagram for describing a method of manufacturing the negative electrode according to embodimentan embodiment of the present disclosure.

FIG. 4 is a sectional diagram for describing the method of manufacturing the negative electrode following FIG. 3.

FIG. 5 is a sectional diagram for describing the method of manufacturing the negative electrode following FIG. 4.

FIG. 6 is a sectional diagram illustrating, in an enlarged manner, a configuration of a portion of a precursor illustrated in FIG. 3.

FIG. 7 is a sectional diagram illustrating, in an enlarged manner, a configuration of a portion of the precursor illustrated in FIG. 4.

FIG. 8 is a sectional diagram illustrating a configuration of a battery according to embodimentan embodiment of the present disclosure.

FIG. 9 is a diagram schematically illustrating a result of an element analysis of a negative electrode (Comparative example 1) in a depth direction based on the X-ray photoelectron spectroscopy.

FIG. 10 is a sectional diagram for describing a method of measuring an interface resistance.

### DETAILED DESCRIPTION

Although consideration has been given in various ways regarding a configuration of a negative electrode, an electrical characteristic of the negative electrode is not sufficient yet. Accordingly, there is room for improvement in terms of the electrical characteristic of the negative electrode.

It is desirable to provide a negative electrode, a method of manufacturing the same, and a battery that each make it possible to achieve a superior electrical characteristic.

The present disclosure will described in further detail including with reference to the accompanying drawings according to an embodiment. Note that the following description is directed to illustrative examples of the present disclosure and not to be construed as limiting to the present disclosure. Factors including, without limitation, numerical values, shapes, materials, components, positions of the components, and how the components are coupled to each other are illustrative only and not to be construed as limiting to the present disclosure. Further, elements in the following embodiments which are not recited in a most-generic independent claim of the present disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the present disclosure are unillustrated in the drawings.

A description is given first of a negative electrode according to an embodiment of the present disclosure.

The negative electrode is used in an electrochemical device that performs various operations by utilizing an electrochemical reaction. The electrochemical device is not particularly limited in kind, and non-limiting examples thereof include a battery and a capacitor. Note that the battery may be a primary battery or a secondary battery.

As will be described later, the negative electrode includes lithium metal. Thus, during an electrode reaction, lithium is extracted from the negative electrode in an ionic state, and the extracted lithium is inserted into the negative electrode in an ionic state.

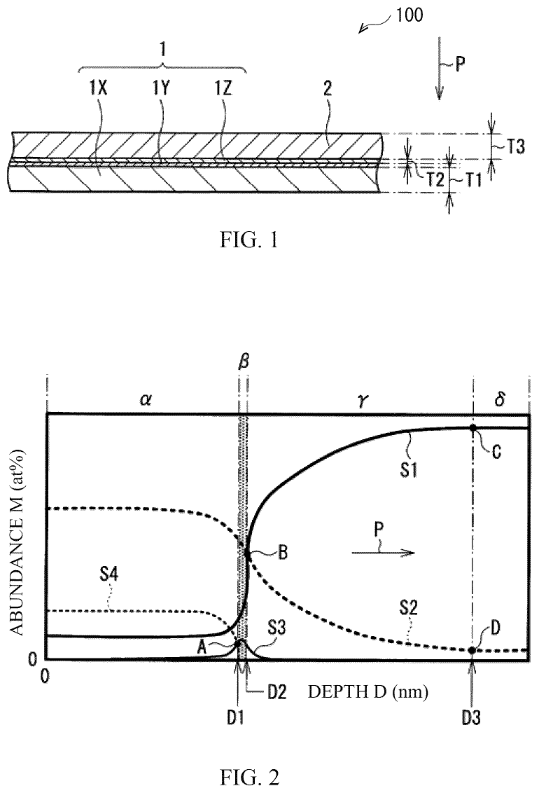

FIG. 1 illustrates a sectional configuration of a negative electrode 100. Note that FIG. 1 illustrates only a portion of the negative electrode 100.

As illustrated in FIG. 1, the negative electrode 100 includes an active material layer 1 and an inorganic solid electrolyte layer 2. A depth direction P illustrated in FIG. 1 is a direction from the inorganic solid electrolyte layer 2 toward the active material layer 1 (a direction toward a lower side in FIG. 1).

In the following description, for convenience, an upper side in FIG. 1 is referred to as an upper side of the negative electrode 100, and the lower side in FIG. 1 is referred to as a lower side of the negative electrode 100.

The active material layer 1 is a layer from which lithium is extracted and into which lithium is inserted in an ionic state during the electrode reaction, and includes lithium metal. For example, the active material layer 1 includes a lithium metal layer 1X, an intermediate layer 1Y, and a surface layer 1Z in this order from a side far from the inorganic solid electrolyte layer 2. In other words, the active material layer 1 has a structure in which the lithium metal layer 1X, the intermediate layer 1Y, and the surface layer 1Z are stacked in this order.

The lithium metal layer 1X is a source of lithium and is, for example, a lithium metal foil.

Note that, a purity of the lithium metal layer 1X, that is, a purity of the lithium metal is not necessarily limited to 100%. In an embodiment, the lithium metal layer 1X may include a small amount of impurities within a realistic range due to a factor such as that involved in a method of manufacturing the lithium metal foil.

A thickness T1 of the lithium metal layer 1X is not particularly limited as long as the thickness T1 is within a range that ensures a sufficient amount of lithium extracted and a sufficient amount of lithium inserted. Note that a procedure of identifying the thickness T1 will be described later.

In an embodiment, the thickness T1 may be 10 μm or greater. In an embodiment, the thickness T1 may be within a range from 10 μm to 1000 μm both inclusive. One reason for this is that because the thickness T1 is sufficiently large, it is possible for a sufficient amount of lithium to be extracted from and inserted into the lithium metal layer 1X in an ionic state during the electrode reaction.

For example, as will be described later, in a manufacturing process of the negative electrode 100, the active material layer 1 including the lithium metal layer 1X, the intermediate layer 1Y, and the surface layer 1Z is formed by subjecting a precursor 3 to a rolling process, following which the inorganic solid electrolyte layer 2 is formed on the surface layer 1Z of the active material layer 1. In contrast, as the manufacturing process of the negative electrode 100, the lithium metal layer 1X may be formed by depositing lithium metal on the inorganic solid electrolyte layer 2 using a vapor phase film forming method such as a vacuum deposition method.

However, when the lithium metal layer 1X is formed using the vapor phase film forming method, it is difficult to form the lithium metal layer 1X to have the thickness T1 that is sufficiently large, due to a film forming principle of the vapor phase film forming method. For example, the thickness T1 when the vapor phase film forming method is used is approximately several tens of nanometers at most. As a result, it is difficult for a sufficient amount of lithium to be extracted from and inserted into the lithium metal layer 1X in an ionic state during the electrode reaction due to the thickness T1 being small.

In contrast, when the active material layer 1 is formed using the rolling process of the precursor 3, the thickness T1 is determined depending on conditions including, without limitation, progress of the rolling process and the number of times the rolling process is performed. This helps to allow the lithium metal layer 1X to be formed with the thickness T1 that is sufficiently large to a degree that is not achievable when the vapor phase film forming method is used. For example, the thickness T1 when the rolling process of the precursor 3 is used is 10 μm or greater, as described above. As a result, it is possible for a sufficient amount of lithium to be extracted from and inserted into the lithium metal layer 1X in an ionic state during the electrode reaction owing to the thickness T1 being sufficiently large.

The intermediate layer 1Y is a layer that has been a portion of the lithium metal layer 1X at and in the vicinity of a surface thereof but has been modified. For example, the intermediate layer 1Y is formed owing to a reaction of lithium with, for example, oxygen and moisture in the environment at and in the vicinity of the surface of the lithium metal layer 1X. As a result, the intermediate layer 1Y includes lithium and oxygen as constituent elements. For example, the intermediate layer 1Y includes lithium oxide (Li₂O).

The surface layer 1Z is an outermost layer of the active material layer 1 and is adjacent to the inorganic solid electrolyte layer 2. For example, the surface layer 1Z is interposed between the intermediate layer 1Y and the inorganic solid electrolyte layer 2, and has a thickness T2. Note that a procedure of identifying the thickness T2 will be described later.

The surface layer 1Z is another layer that has been a portion of the lithium metal layer 1X at and in the vicinity of the surface thereof but has been modified. For example, the surface layer 1Z is formed owing to reaction of lithium with, for example, oxygen, carbon dioxide, and moisture in the environment at and in the vicinity of the surface of the lithium metal layer 1X. As a result, the surface layer 1Z includes lithium, oxygen, and carbon as constituent elements.

For example, the surface layer 1Z includes, for example, lithium carbonate (Li₂CO₃) and lithium hydroxide (LiOH). Note that the surface layer 1Z, in some cases, further includes any organic material.

Any of the materials including, without limitation, lithium carbonate included in the surface layer 1Z acts as an unnecessary component (hereinafter, referred to as a “high-resistance component”) having a high electric resistance. This increases an electric resistance (hereinafter, referred to as an “interface resistance R”) at an interface between the active material layer 1 and the inorganic solid electrolyte layer 2. In this case, when the thickness T2 is increased, the surface layer 1Z is formed in a larger amount, causing the interface resistance R to be easily increased.

To simplify illustration, FIG. 1 illustrates a case where the intermediate layer 1Y and the surface layer 1Z are provided only on one side (an upper surface) of the lithium metal layer 1X. In an embodiment, the intermediate layer 1Y and the surface layer 1Z may be provided on each of both sides (the upper surface and a lower surface) of the lithium metal layer 1X.

Here, as described above, the rolling process of the precursor 3 is used in the manufacturing process of the negative electrode 100. Accordingly, the negative electrode 100 has an appropriate configuration and an appropriate physical property that help to decrease the interface resistance R. The example configuration and physical property of the negative electrode 100 will be described later.

The inorganic solid electrolyte layer 2 is provided on the active material layer 1. Thus, a surface (the surface layer 1Z) of the active material layer 1 is covered with the inorganic solid electrolyte layer 2. As a result, the inorganic solid electrolyte layer 2 serves as a protective film that protects the surface of the active material layer 1.

For example, the inorganic solid electrolyte layer 2 protects the surface of the active material layer 1 from, for example, oxygen, carbon dioxide, and moisture present in the environment. Thus, the inorganic solid electrolyte layer 2 suppresses additional formation of the high-resistance component (the surface layer 1Z) on the outermost surface of the active material layer 1, for example, between the intermediate layer 1Y and the inorganic solid electrolyte layer 2.

In addition, the inorganic solid electrolyte layer 2 suppresses precipitation of lithium on the surface of the active material layer 1 in a metallic state when lithium is extracted from and inserted into the negative electrode 100 in an ionic state. This suppresses growth of lithium dendrites on the surface of the active material layer 1, and thus suppresses occurrence of a short circuit caused by the lithium dendrites in the electrochemical device in which the negative electrode 100 is used together with a positive electrode. This helps to improve safety and lifetime of the electrochemical device are improved.

In an embodiment where the inorganic solid electrolyte layer 2 includes lithium as a constituent element, the inorganic solid electrolyte layer 2 may serve as the source of lithium similarly to the lithium metal layer 1X.

Here, as described above, because the intermediate layer 1Y and the surface layer 1Z are provided only on one side of the lithium metal layer 1X, the inorganic solid electrolyte layer 2 is provided only on one side (the upper surface) of the active material layer 1. In an embodiment where the intermediate layer 1Y and the surface layer 1Z are provided on each of both sides of the lithium metal layer 1X, the inorganic solid electrolyte layer 2 may be provided on each of both sides (the upper surface and the lower surface) of the active material layer 1.

The inorganic solid electrolyte layer 2 includes a characteristic element as a constituent element. For example, the inorganic solid electrolyte layer 2 includes any one or more of inorganic solid electrolyte materials. The characteristic element includes any one or more of elements different from lithium, carbon, and oxygen. In other words, the inorganic solid electrolyte layer 2 includes an element (the characteristic element) not included in the active material layer 1 (the lithium metal layer 1X, the intermediate layer 1Y, and the surface layer 1Z). The characteristic element may include only one element or may include two or more elements. The crystalline state of the inorganic solid electrolyte material is not particularly limited. In an embodiment, the crystalline state of the inorganic solid electrolyte material may be crystalline, amorphous (non-crystalline), or may include both a crystalline part and an amorphous part.

The kind of the inorganic solid electrolyte material is not particularly limited, and may be chosen as desired. Non-limiting examples of the inorganic solid electrolyte material include, but not limited to, amorphous Li₃PO₄ (LPO), LiPON, Li₇La₃Zr₂O₁₂ (LLZO), LiSiCON, Li_{1.4}Ti₂Si_{0.4}P_{2.6}O₁₂—AlPO₄ (LATP), alumina, Li₃PS₄ (LPS), Li₁₀GeP₂S₁₂ (LGPS), argyrodite (Li₆PS₅Cl), and polyethylene oxide (PEO). Note that the composition of each of LPO, LLZO, LATP, LPS, LGPS, and argyrodite is not limited to the above-described composition, and may be changed as desired. The characteristic elements included in the above-described examples of the inorganic solid electrolyte material are, for example, phosphorus, zirconium, silicon, titanium, aluminum, sulfur, and germanium.

In an embodiment, the inorganic solid electrolyte material may include lithium, oxygen, and phosphorus, which is the characteristic element, as constituent elements, and a content of lithium in the inorganic solid electrolyte material may be within a range from 10 at % to 60 at % both inclusive. One reason for this is that this makes it easier for the inorganic solid electrolyte layer 2 to serve sufficiently as the protective film, and for the inorganic solid electrolyte layer 2 to also serve sufficiently as the source of lithium.

Accordingly, in an embodiment, the inorganic solid electrolyte material may include any one or more of materials including, but not limited to, amorphous Li₃PO₄ and LiPON.

A thickness T3 of the inorganic solid electrolyte layer 2 is not limited as long as the inorganic solid electrolyte layer 2 is allowed to serve as the protective film and the source of lithium. In an embodiment, the thickness T3 may be within a range from 10 nm to 20,000 nm both inclusive. One reason for this is that this makes it easier for the inorganic solid electrolyte layer 2 to serve sufficiently as the protective film, and for the inorganic solid electrolyte layer 2 to also serve sufficiently as the source of lithium. Note that a procedure of identifying the thickness T3 will be described later.

FIG. 2 schematically illustrates a result (photoelectron spectra) of an element analysis of the negative electrode 100 (the active material layer 1 and the inorganic solid electrolyte layer 2) in the depth direction P based on X-ray photoelectron spectroscopy (XPS). In FIG. 2, a horizontal axis represents a depth D (nm), and a vertical axis represents an abundance M (at %).

Here, the inorganic solid electrolyte layer 2 includes lithium, oxygen, and the characteristic element (phosphorus) as constituent elements. For example, the inorganic solid electrolyte layer 2 includes amorphous Li₃PO₄. Accordingly, FIG. 2 illustrates a lithium (Li1s) spectrum S1 (thick solid line) that is a spectrum derived from lithium, an oxygen (O1s) spectrum S2 (thick broken line) that is a spectrum derived from oxygen, a carbon (C1s) spectrum S3 (thin solid line) that is a spectrum derived from carbon, and a phosphorus (P2p) spectrum S4 (thin broken line) that is a spectrum derived from the characteristic element (phosphorus).

The photoelectron spectra illustrated in FIG. 2 are obtainable by performing the element analysis of the negative electrode 100 in the depth direction P based on XPS. As is apparent from FIG. 2, the depth direction P is a direction in which the depth D increases.

In the element analysis of the negative electrode 100, an etching process using ion sputtering and measurement of an abundance of each of the elements (lithium, oxygen, carbon, and phosphorus) are alternately repeated to measure the abundance of each of the elements while etching a surface of the negative electrode 100. Accordingly, FIG. 2 illustrates a relationship between the depth D (the horizontal axis), which is what is called a sputter depth, and the abundance M (the vertical axis) of each of the elements.

Here, as described above, the negative electrode 100 includes the active material layer 1 and the inorganic solid electrolyte layer 2 (amorphous Li₃PO₄), and the active material layer 1 includes the lithium metal layer 1X (lithium metal), the intermediate layer 1Y (e.g., lithium oxide), and the surface layer 1Z (e.g., lithium carbonate). For example, in the negative electrode 100, the inorganic solid electrolyte layer 2, the surface layer 1Z, the intermediate layer 1Y, and the lithium metal layer 1X are arranged in this order in the depth direction P.

Thus, the abundance M of each of the elements (lithium, oxygen, carbon, and phosphorus) varies as described below. In the following, the abundance M of lithium is referred to as ML, the abundance M of oxygen is referred to as MO, the abundance M of carbon is referred to as MC, and the abundance M of phosphorus is referred to as MP.

As is apparent from a behavior of the lithium spectrum S1, the abundance ML increases sharply from a substantially constant state and thereafter becomes substantially constant.

As is apparent from a behavior of the oxygen spectrum S2, the abundance MO decreases sharply from a substantially constant state and thereafter becomes substantially constant.

As is apparent from a behavior of the carbon spectrum S3, the abundance MC temporarily increases from substantially 0 at % and thereafter decreases to become substantially 0 at % again.

As is apparent from a behavior of the phosphorus spectrum S4, the abundance MP decreases sharply from a substantially constant state to substantially 0 at %.

Here, attention is paid to a point (a point A as a first intersection) at which the phosphorus spectrum S4 and the carbon spectrum S3 intersect each other, a point (a point B as a second intersection) at which the lithium spectrum S1 and the oxygen spectrum S2 intersect each other, a point (a point C) at which the abundance ML finally starts to be substantially constant in the lithium spectrum S1, and a point (a point D) at which the abundance MO finally starts to be substantially constant in the oxygen spectrum S2. Note that “the abundance ML is substantially constant” refers to that an amount of variation of the abundance ML is within ±2.5 at %, and “the abundance MO is substantially constant” refers to that an amount of variation of the abundance MO is within ±2.5 at %.

In this case, the point A corresponds to a position of a border between the inorganic solid electrolyte layer 2 and the active material layer 1, for example, a position of an interface between the inorganic solid electrolyte layer 2 and the surface layer 1Z. The point B corresponds to a position of a border (an interface) between the surface layer 1Z and the intermediate layer 1Y. Each of the points C and D corresponds to a position of a border (an interface) between the intermediate layer 1Y and the lithium metal layer 1X.

The depth D corresponding to the point A is referred to as D1, the depth D corresponding to the point B is referred to as D2, and the depth D corresponding to each of the points C and D is referred to as D3. Accordingly, a range (a region α) where the depth D is from 0 to D1 corresponds to a region where the inorganic solid electrolyte layer 2 is present. A range (a region β) where the depth D is from D1 to D2 corresponds to a region where the surface layer 1Z is present. A range (a region γ) where the depth D is from D2 to D3 corresponds to a region where the intermediate layer 1Y is present. A range (a region δ) where the depth D is D3 or greater corresponds to a region where the lithium metal layer 1X is present. In FIG. 2, the region β, which is the region where the surface layer 1Z is present, is shaded.

The depth D1 corresponds to the thickness T3 of the inorganic solid electrolyte layer 2, and the depth D2-D1 corresponds to the thickness T2 of the surface layer 1Z.

Thus, the abundance ML increases sharply when the depth D is equal to or near D1 and thereafter becomes substantially constant when the depth D is equal to D3. One reason for this is that although the inorganic solid electrolyte layer 2, the surface layer 1Z, the intermediate layer 1Y, and the lithium metal layer 1X each include lithium as a constituent element, the content of lithium is greater in the lithium metal layer 1X than in the inorganic solid electrolyte layer 2.

The abundance MO decreases sharply when the depth D is equal to and near D1 and thereafter becomes substantially constant when the depth D is equal to D3. One reason for this is that while each of the inorganic solid electrolyte layer 2, the intermediate layer 1Y, and the surface layer 1Z includes oxygen as a constituent element, the lithium metal layer 1X hardly includes oxygen as a constituent element.

The abundance MC is initially substantially 0 at %, but temporarily increases when the depth D is equal to or near D1, and thereafter decreases when the depth D is equal to or near D2 to become approximately 0 at % again. One reason for this is that the surface layer 1Z includes carbon as a constituent element, but each of the inorganic solid electrolyte layer 2, the intermediate layer 1Y, and the lithium metal layer 1X hardly includes carbon as a constituent element.

The abundance MP decreases sharply when the depth D is equal to or near D1 to be substantially 0 at %. One reason for this is that while the inorganic solid electrolyte layer 2 includes phosphorus, which is the characteristic element, as a constituent element, each of the surface layer 1Z, the intermediate layer 1Y, and the lithium metal layer 1X hardly includes phosphorus, which is the characteristic element, as a constituent element.

Here, a change in each of the abundances ML, MO, MC, and MP when the inorganic solid electrolyte layer 2 includes amorphous Li₃PO₄ as described above has been described. However, depending on a composition of the inorganic solid electrolyte layer 2, each of the abundances ML, MO, MC, and MP may behave differently.

For example, when the content of lithium in the inorganic solid electrolyte layer 2 is great, the abundance ML decreases when the depth D is equal to or near D1 and thereafter increases.

Further, when the inorganic solid electrolyte layer 2 includes carbon as a constituent element, the abundance MC temporarily increases when the depth D is equal to or near D1 from a state where the abundance is initially greater than 0 at %.

Note that conditions of the element analysis of the negative electrode 100 based on XPS are as described below. As an analyzer, for example, an X-ray photoelectron spectrometer (scanning X-ray photoelectron spectrometer PHI5000 VersaProbe available from ULVAC-PHI Inc. located in Kanagawa, Japan) is used. An environmental condition inside an analysis chamber is set to, for example, an ultra-high vacuum of 1.5×10⁻⁶ Pa or less, although not particularly limited thereto. A sputter rate at a time of the etching process is set to, for example, 3.2 mm/min in terms of silicon dioxide (SiO₂), although not particularly limited thereto. In addition, conditions of the analysis are as follows: X-ray source: monochromatized A1 Kα ray (1486.6 eV); X-ray spot diameter: 100 μm; sputter condition: Ar⁺, 1 kV, 1 mm×mm; and charge neutralization: none.

As illustrated in FIG. 2, the following condition is satisfied in the result of the element analysis of the negative electrode 100 (the active material layer 1 and the inorganic solid electrolyte layer 2) in the depth direction P based on XPS.

An abundance ratio Z1 (=ML/MC) that is a ratio of the abundance ML to the abundance MC is greater than 2 at any position (the depth D) within the range of the surface layer 1Z (the region β, which is the range from the point A to the point B). In other words, in the surface layer 1Z, the abundance ML is sufficiently greater than the abundance MC. Thus, the surface layer 1Z includes a sufficient amount of lithium therein, but includes hardly any carbon.

A reason why the abundance ratio Z1 is greater than 2 at any depth D within the range of the surface layer 1Z is that an occupation range of lithium is sufficiently increased with respect to an occupation range of carbon inside the surface layer 1Z, which suppresses an increase in the interface resistance R due to presence of the high-resistance component. The high-resistance component described here is a carbon-containing component such as lithium carbonate as described above.

Thus, when the condition regarding the abundance ratio Z1 described above is satisfied, the interface resistance R is decreased as compared with when the condition regarding the abundance ratio Z1 is not satisfied. This improves ion conductivity between the active material layer 1 and the inorganic solid electrolyte layer 2.

Note that the reason why the abundance ratio Z1 is greater than 2 at any depth D within the range of the surface layer 1Z is that, as described above, the rolling process of the precursor 3 is used to form the active material layer 1 in the manufacturing process of the negative electrode 100. A reason why the abundance ratio Z1 becomes greater than 2 upon use of the rolling process of the precursor 3 will be described later.

It is possible to calculate the abundance ratio Z1 based on the photoelectron spectra (the lithium spectrum S1 and the carbon spectrum S3) illustrated in FIG. 2.

For example, in calculating the abundance ratio Z1, each of the abundances ML and MC is identified in the range (the region β) of the surface layer 1Z, following which the abundance ratio Z1 is calculated based on the identified abundances ML and MC.

In order to verify whether the abundance ratio Z1 is greater than 2 at any depth D within the range of the surface layer 1Z, the abundance ratio Z1 is calculated based on a minimum value of the abundance ML and a maximum value of the abundance MC within the range of the surface layer 1Z, following which it is determined whether the calculated abundance ratio Z1 is greater than 2.

Accordingly, when the calculated abundance ratio Z1 is greater than 2, the condition is satisfied that the abundance ratio Z1 is greater than 2 at any depth D within the range of the surface layer 1Z. In contrast, when the calculated abundance ratio Z1 is 2 or less, the condition is not satisfied that the abundance ratio Z1 is greater than 2 at any depth D within the range of the surface layer 1Z.

Note that an abundance ratio Z2 (=MO/MC) that is a ratio of the abundance MO to the abundance MC within the range (the region β) of the surface layer 1Z is not particularly limited.

In an embodiment, the abundance ratio Z2 may be greater than 3 at any position (the depth D) within the range of the surface layer 1Z. One reason for this is that an occupation range of oxygen is sufficiently increased with respect to the occupation range of carbon inside the surface layer 1Z, which further suppresses an increase in the interface resistance R due to the presence of the high-resistance component.

It is possible to calculate the abundance ratio Z2 based on the photoelectron spectra (the oxygen spectrum S2 and the carbon spectrum S3) illustrated in FIG. 2. For example, in calculating the abundance ratio Z2, each of the abundances MO and MC is identified in the range (the region β) of the surface layer 1Z, following which the abundance ratio Z2 is calculated based on the identified abundances MO and MC.

In order to verify whether the abundance ratio Z2 is greater than 3 at any depth D within the range of the surface layer 1Z, the abundance ratio Z2 is calculated based on a minimum value of the abundance MO and the maximum value of the abundance MC within the range of the surface layer 1Z, following which it is determined whether the calculated abundance ratio Z2 is greater than 3.

Accordingly, when the calculated abundance ratio Z2 is greater than 3, the condition is satisfied that the abundance ratio Z2 is greater than 3 at any depth D within the range of the surface layer 1Z. In contrast, when the calculated abundance ratio Z2 is 3 or less, the condition is not satisfied that the abundance ratio Z2 is greater than 3 at any depth D within the range of the surface layer 1Z.

In the manufacturing process of the negative electrode 100, as described above, the rolling process of the precursor 3 is used to form the active material layer 1. Accordingly, the surface layer 1Z is stretched in the rolling process of the precursor 3, which causes the thickness T2 of the surface layer 1Z to become sufficiently small.

In an embodiment, the thickness T2 may be 100 nm or less. One reason for this is that the thickness T2 of an extra layer interposed between the intermediate layer 1Y and the inorganic solid electrolyte layer 2, or for example, the surface layer 1Z including the high-resistance component, becomes sufficiently small, which further decreases the interface resistance R.

Note that procedures of identifying the respective thicknesses T1, T2, and T3 are as described below.

In identifying the thickness T2 of the surface layer 1Z, each of the depths D1 and D2 is identified based on the photoelectron spectra illustrated in FIG. 2, following which the thickness T2 is calculated based on a calculation expression: T2=D2−D1.

In identifying the thickness T3 of the inorganic solid electrolyte layer 2, the depth D1 is identified based on the photoelectron spectra illustrated in FIG. 2. Accordingly, because T3 is equal to D1, the thickness T3 is identified based on the depth D1.

In an embodiment, in identifying the thickness T3, an electron micrograph may be used instead of using the result of the element analysis (photoelectron spectra) based on XPS.

For example, a section of the negative electrode 100 is exposed by first cutting the negative electrode 100 using a cutting instrument such as a microtome. In this case, the negative electrode 100 is cut in the depth direction P to cause a section of the active material layer 1 and a section of the inorganic solid electrolyte layer 2 to be exposed.

Thereafter, an electron micrograph is obtained by observing the section of the negative electrode 100 using an electron microscope. As the electron microscope, any one or more of microscopes including, without limitation, a scanning electron microscope (SEM) and a transmission electron microscope (TEM) are used. An observation magnification may be set as desired as long as the magnification allows for observation of both the active material layer 1 and the inorganic solid electrolyte layer 2 in the depth direction P.

Thereafter, the thickness T3 of the inorganic solid electrolyte layer 2 is measured based on the electron micrograph. In this case, the thickness T3 of the inorganic solid electrolyte layer 2 is measured at ten locations that differ from each other, following which an average value of the ten thicknesses T3 is calculated.

As will be described later, the inorganic solid electrolyte layer 2 is formed on the active material layer 1 using, for example, the vapor phase film forming method in the manufacturing process of the negative electrode 100, which provides an interface that is a physical border between the active material layer 1 and the inorganic solid electrolyte layer 2. Accordingly, in the electron micrograph, the border between the active material layer 1 and the inorganic solid electrolyte layer 2 is visually recognizable based on the position of the interface. This makes it possible to measure the thickness T3 based on the position of the interface.

In identifying the thickness T1 of the lithium metal layer 1X, the depth D3 is identified based on the photoelectron spectra illustrated in FIG. 2. The depth D3 corresponds to a sum of the thickness T3 of the inorganic solid electrolyte layer 2, the thickness T2 of the surface layer 1Z, and the thickness of the intermediate layer 1Y.

Note that when the position (the depth D) of the point C and the position (the depth D) of the point D do not coincide with each other, the depth D3 is determined based on either the point C or the point D at a position with a greater depth D.

Thereafter, the thickness T1 is calculated by subtracting the depth D3 from the thickness of the entire negative electrode 100.

In the negative electrode 100, during the electrode reaction, lithium is extracted in an ionic state from the lithium metal layer 1X included in the active material layer 1 through the inorganic solid electrolyte layer 2, and the extracted lithium is inserted in an ionic state into the lithium metal layer 1X through the inorganic solid electrolyte layer 2.

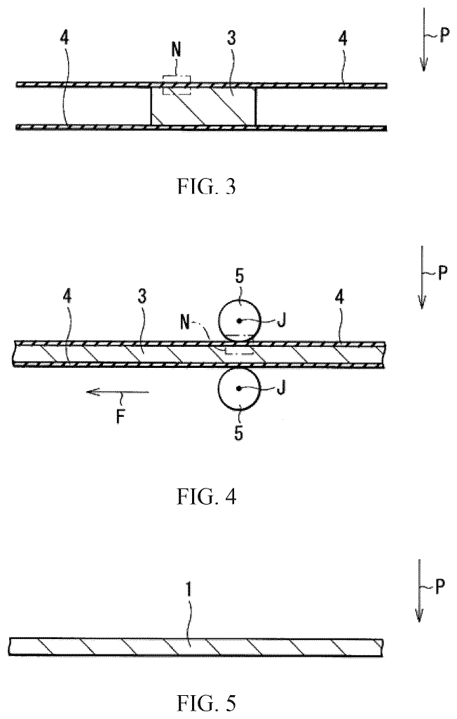

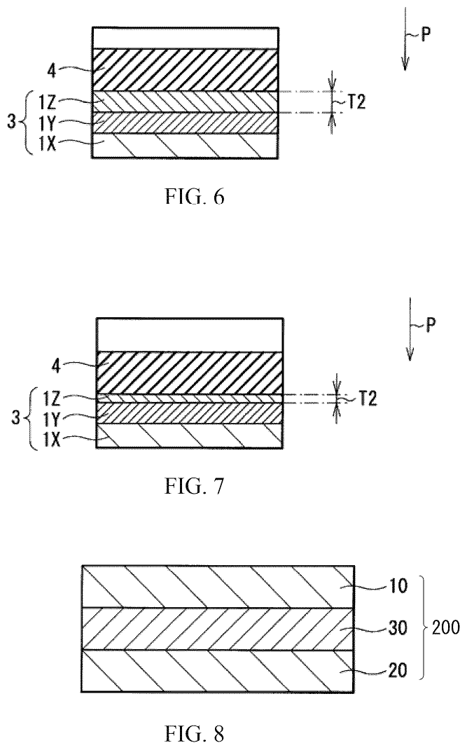

FIGS. 3, 4, and 5 each illustrate a sectional configuration corresponding to FIG. 1 in order to describe a method of manufacturing the negative electrode 100. FIGS. 6 and 7 each illustrate, in an enlarged manner, a sectional configuration of a portion (a part N) of the precursor 3 used in the method of manufacturing the negative electrode 100. Note that FIG. 6 corresponds to FIG. 3, and FIG. 7 corresponds to FIG. 4. FIGS. 6 and 7 each also illustrate a protective film 4.

In manufacturing the negative electrode 100, first, the precursor 3 is prepared as illustrated in FIG. 3. The precursor 3 is a mass of lithium metal used to form the active material layer 1 and is what is called a lithium ingot. Note that the precursor 3 may be lithium metal in foil form (a lithium foil).

For example, the precursor 3 has a configuration similar to that of the active material layer 1 except that the precursor 3 has a thickness larger than the thickness of the active material layer 1. For example, as illustrated in FIG. 6, the precursor 3 has a structure in which the lithium metal layer 1X, the intermediate layer 1Y, and the surface layer 1Z are stacked in this order. Example details of each of the lithium metal layer 1X, the intermediate layer 1Y, and the surface layer 1Z are as described above.

Note that the thickness T2 of the surface layer 1Z in the precursor 3 is sufficiently larger than the thickness T2 of the surface layer 1Z in the finally manufactured active material layer 1. One reason for this is that, in the precursor 3 stored in a normal environment such as in the atmosphere, lithium reacts with, for example, oxygen, carbon dioxide, and moisture at and in the vicinity of the surface of the lithium metal layer 1X as described above, which increases the thickness T2.

Note that a method of preparing the precursor 3 is not particularly limited. For example, a method of preparing the precursor 3 in foil form is as described below.

In an embodiment, the lithium foil may be etched by irradiating a surface of the lithium foil with an inert ion gas in a vacuum atmosphere. As a result, the thickness of the lithium foil is reduced, and thus the precursor 3 in foil form is obtainable.

In an embodiment, the lithium ingot may be melted inside a glove box. As a result, the lithium foil is obtainable, and thus the precursor 3 in foil form is obtainable. A condition of an atmosphere inside the glove box is not particularly limited, and thus may be set as desired. For example, in an argon gas atmosphere, an oxygen concentration is set to 0.2 ppm, and a temperature is set to 250° C. or higher.

Thereafter, the precursor 3 is rolled in a thickness direction in a reduced-pressure environment or an inert gas atmosphere. Hereinafter, the reduced-pressure environment or the inert gas atmosphere is also simply referred to as a “same environment”.

A condition of the reduced-pressure environment is not particularly limited. In an embodiment, a pressure may be a vacuum of 1×10⁻¹ Pa or less. Non-limiting examples of an inert gas used for the inert gas atmosphere include any one or more of gases including, without limitation, an argon gas, a helium gas, and a krypton gas. A condition of the inert gas atmosphere is not particularly limited. In an embodiment, an oxygen concentration may be 0.2 ppm or less. In an embodiment, the inert gas may include the argon gas. One reason for this is that, upon the rolling process of the precursor 3, the high-resistance component is prevented from being easily formed newly on the surface of the precursor 3.

In order to provide each of the reduced-pressure environment and the inert gas atmosphere, a sealed chamber is used in which conditions including, without limitation, the pressure, a kind of gas, and the oxygen concentration are allowed to be set as desired. Non-limiting examples of the sealed chamber include the glove box and a vacuum device.

In an embodiment, as illustrated in FIG. 3, in the same environment, a pair of protective films 4 may be prepared, following which the precursor 3 may be disposed between the pair of protective films 4. In this case, the protective films 4 are each brought into close contact with the precursor 3 to cause the protective films 4 to be opposed to each other with the precursor 3 interposed therebetween.

The protective films 4 may each correspond to a specific but non-limiting example of a “protective member” in an embodiment of the present disclosure. The protective films 4 physically and chemically protect a surface of the precursor 3 during the rolling process to be described later, and each include a polymer compound. A thickness of each of the protective films 4 is not particularly limited and may be set as desired.

The polymer compound is not particularly limited in kind. In an embodiment, polymer compound may include any one or more of polyolefins. One reason for this is that the polyolefin has low reactivity to the precursor 3 (the lithium metal), and thus, when the protective films 4 are brought into close contact with the precursor 3 during the rolling process, deterioration of the precursor 3 otherwise caused by a chemical reaction between the precursor 3 and the protective films 4 is suppressed.

For example, when the protective films 4 each include the polymer compound having high reactivity to the precursor 3 (the lithium metal), the protective films 4 easily react with the lithium metal during the rolling process.

In this case, due to the reaction between the protective films 4 and the lithium metal, a side reaction product having a high resistance, i.e., an impurity is easily formed on the surfaces of the precursor 3, and a color of the precursor 3 is easily changed from silver white to black. This causes the precursor 3 to easily deteriorate at and in the vicinity of the surfaces. Accordingly, the interface resistance R is easily increased when the inorganic solid electrolyte layer 2 is formed on the active material layer 1 in a following process.

In contrast, when the protective films 4 each include the polymer compound having low reactivity to the precursor 3 (the lithium metal), the protective films 4 are prevented from easily reacting with the lithium metal during the rolling process.

In this case, the side reaction product having the high resistance is prevented from being easily formed on the surfaces of the precursor 3, and the color of the precursor 3 is prevented from being easily changed from silver white to black. This prevents the precursor 3 from easily deteriorating at and in the vicinity of the surfaces. Accordingly, the interface resistance R is prevented from being easily increased when the inorganic solid electrolyte layer 2 is formed on the active material layer 1.

Non-limiting examples of the polyolefins include polyethylene and polypropylene. Note that, for reference, non-limiting examples of the polymer compound having high reactivity to the precursor 3 (the lithium metal) described above include Teflon (registered trademark) and Kapton.

After the precursor 3 is disposed between the pair of protective films 4, the precursor 3 is subjected to the rolling process as illustrated in FIG. 4. In an embodiment, in the same environment, the precursor 3 may be rolled by pressing the precursor 3 through the pair of protective films 4 in a direction (the thickness direction of the precursor 3) in which the protective films 4 are opposed to each other. In this case, use of lubricant is not required.

Here, a roll pressing machine is used to perform the rolling process of the precursor 3. The roll pressing machine includes a pair of rollers 5 that is movable in a moving direction F. The rollers 5 are rotatable about respective rotation axes J extending in a direction intersecting the moving direction F.

In this case, the precursor 3 and the pair of protective films 4 are disposed between the pair of rollers 5, and the rollers 5 are in close contact with the respective protective films 4. For example, the roller 5 positioned above the precursor 3 is in close contact with the protective film 4 also positioned above the precursor 3. In addition, the roller 5 positioned below the precursor 3 is in close contact with the protective film 4 also positioned below the precursor 3.

In the rolling process of the precursor 3, the rollers 5 rotate about the respective rotation axes J to thereby move in the moving direction F while pressing the precursor 3 through the respective protective films 4 in the direction in which the protective films 4 are opposed to each other. For example, an upper one of the rollers 5 moves in the moving direction F while pressing the precursor 3 through an upper one of the protective films 4. In addition, a lower one of the rollers 5 moves in the moving direction F while pressing the precursor 3 through a lower one of the protective films 4.

In an embodiment, in rolling the precursor 3, the precursor 3 may be crushed in advance using an instrument such as a pestle in order to facilitate the rolling of the precursor 3 using the roll pressing machine (the pair of rollers 5).

As a result, the precursor 3 is stretched, and thus the precursor 3 is formed into a thin sheet shape.

In this case, as illustrated in FIG. 7, not only the lithium metal layer 1X is stretched, but also the surface layer 1Z is stretched together. This reduces the thickness T1 of the lithium metal layer 1X and also the thickness T2 of the surface layer 1Z in a similar manner. In this case, in an embodiment, the thickness of the intermediate layer 1Y may also be reduced in a similar manner.

When the surface layer 1Z is stretched, the high-resistance component such as lithium carbonate present on the surface of the intermediate layer 1Y is removed in response to a reduction in the thickness T2 of the surface layer 1Z. As a result, an amount of the surface layer 1Z covering the surface of the intermediate layer 1Y is reduced, and the abundance of the high-resistance component included in the surface layer 1Z is reduced. This allows the above-described condition regarding the abundance ratio Z1 to be satisfied, and allows the thickness T2 to become 100 nm or less. Thus, the interface resistance R is decreased when the inorganic solid electrolyte layer 2 is formed on the active material layer 1 in the following process.

When the precursor 3 is rolled using the roll pressing machine, the rolling process is performed until the thickness of the precursor 3 reaches a desired thickness. In an embodiment, the number of times the rolling process is performed may be only once, or the rolling process may be repeated two or more times.

After the rolling process of the precursor 3 is completed, the pair of protective films 4 is removed by peeling the pair of protective films 4 off the precursor 3 after the rolling. Accordingly, as illustrated in FIGS. 1 and 5, the active material layer 1 including the lithium metal layer 1X, the intermediate layer 1Y, and the surface layer 1Z is formed.

In an embodiment, in a result of an element analysis of the outermost surface of the surface layer 1Z based on XPS after the formation of the active material layer 1 and before the formation of the inorganic solid electrolyte layer 2, the abundance ML may be greater than each of the abundances MO and MC. One reason for this is that, when the inorganic solid electrolyte layer 2 is formed on the active material layer 1 in the following process, the abundance of the high-resistance component is reduced at the interface between the active material layer 1 and the inorganic solid electrolyte layer 2, which sufficiently decreases the interface resistance R.

Thereafter, in the same environment, the inorganic solid electrolyte layer 2 is formed on the surface layer 1Z of the active material layer 1.

A method of forming the inorganic solid electrolyte layer 2 is not particularly limited. In an embodiment, the inorganic solid electrolyte layer 2 may be formed using any one or more of vapor phase film forming methods. One reason for this is that the inorganic solid electrolyte layer 2 is easily formed stably and reproducibly while suppressing the additional formation of the high-resistance component on the surface of the active material layer 1.

Non-limiting examples of the vapor phase film forming method include a vacuum deposition method, a sputtering method, a pulsed laser deposition method (PLD), an atomic layer deposition method (ALD), and a chemical vapor deposition method (CVD).

In an embodiment, in forming the inorganic solid electrolyte layer 2, the active material layer 1 may be formed in the same environment, and thereafter the inorganic solid electrolyte layer 2 may be successively formed in the same environment without exposing the active material layer 1 to the atmosphere. In an embodiment where the active material layer 1 is formed inside the sealed chamber, the inorganic solid electrolyte layer 2 may be successively formed inside the sealed chamber. One reason for this is that this suppresses the additional formation of the high-resistance component on the surface of the active material layer 1, which further decreases the interface resistance R.

For example, after the formation of the active material layer 1, if the active material layer 1 is exposed to the atmosphere, lithium easily reacts with, for example, oxygen, carbon dioxide, and moisture in the atmosphere at and in the vicinity of the surface of the lithium metal layer 1X as described above. In this case, although the thickness T2 is reduced using the rolling process, the thickness T2 is increased again before forming the inorganic solid electrolyte layer 2. This causes the interface resistance R to be easily increased when the inorganic solid electrolyte layer 2 is formed.

In contrast, when the inorganic solid electrolyte layer 2 is formed in the same environment without exposing the active material layer 1 to the atmosphere after the formation of the active material layer 1, lithium is prevented from easily reacting with, for example, oxygen, carbon dioxide, and moisture at and in the vicinity of the surface of the lithium metal layer 1X. This makes it easier to substantially maintain the thickness T2 without causing the thickness T2 to be excessively increased. This allows the interface resistance R to be easily decreased when the inorganic solid electrolyte layer 2 is formed.

In this case, in an embodiment, the inorganic solid electrolyte layer 2 may be promptly formed after the formation of the active material layer 1. One reason for this is that the interface resistance R is sufficiently decreased.

A time between the processes, which is the time up to the formation of the inorganic solid electrolyte layer 2 after the formation of the active material layer 1, is not particularly limited. In an embodiment, the time between the processes may be within two hours. One reason for this is that, given the circumstance in which lithium present at and in the vicinity of the surface of the lithium metal layer 1X easily reacts with, for example, oxygen, carbon dioxide, and moisture that are slightly present in the environment even in the reduced-pressure environment or the inert gas atmosphere, the time between the processes is sufficiently short, making it easier for the thickness T2 to be substantially maintained without being excessively increased. This allows the interface resistance R to be easily decreased when the inorganic solid electrolyte layer 2 is formed.

Note that when the active material layer 1 is to be stored before the formation of the inorganic solid electrolyte layer 2 after the formation of the active material layer 1 depending on some circumstances, in an embodiment, the active material layer 1 may be stored in the same environment. One reason for this is that the thickness T2 is easily maintained sufficiently even during storage of the active material layer 1.

A condition of the reduced-pressure environment during the storage of the active material layer 1 is not particularly limited. In an embodiment where a storage period is one day or less, the pressure may be a vacuum of 1×10⁻¹ Pa or less. In an embodiment where the storage period of the active material layer 1 exceeds one day, the pressure may be a vacuum of 1×10⁻⁴ Pa or less. Note that example details of the inert gas atmosphere are as described above.

As a result, the inorganic solid electrolyte layer 2 is formed on the active material layer 1 (the lithium metal layer 1X, the intermediate layer 1Y, and the surface layer 1Z), and thus the negative electrode 100 is completed.

According to the negative electrode 100 and the method of manufacturing the same, action and example effects described below are obtainable.

The negative electrode 100 includes the active material layer 1 (the lithium metal layer 1X, the intermediate layer 1Y, and the surface layer 1Z) and the inorganic solid electrolyte layer 2. The intermediate layer 1Y includes lithium and oxygen as constituent elements, the surface layer 1Z includes lithium, oxygen, and carbon as constituent elements, and the inorganic solid electrolyte layer 2 includes the characteristic element. In the result of the element analysis of the negative electrode 100 (the active material layer 1 and the inorganic solid electrolyte layer 2) in the depth direction P based on XPS, the abundance ratio Z1 regarding the abundances ML and MC is greater than 2 at any depth D within the range (the region β) of the surface layer 1Z.

In this case, as described above, at and in the vicinity of the interface between the active material layer 1 and the inorganic solid electrolyte layer 2, an increase in the interface resistance R caused by the presence of the high-resistance component (the carbon-containing component) such as lithium carbonate is suppressed. Thus, the interface resistance R is decreased as compared with when the above-described condition regarding the abundance ratio Z1 is not satisfied. This helps to achieve a superior electrical characteristic.

This helps to improve the ion conductivity between the active material layer 1 and the inorganic solid electrolyte layer 2, and thus helps to obtain superior ion conductivity in the negative electrode 100 without additionally providing an ion conductive layer including, for example but not limited to, lithium nitride on the surface of the active material layer 1.

In an embodiment, the abundance ratio Z2 regarding the abundances MO and MC may be greater than 3 at any depth D within the range (the region β) of the surface layer 1Z. This further decreases the interface resistance R, thus helping to achieve higher effects.

In an embodiment, the thickness T2 of the surface layer 1Z may be 100 nm or less. This further decreases the interface resistance R, thus helping to achieve higher effects.

In an embodiment, the thickness T1 of the lithium metal layer 1X may be within the range from 10 μm to 1000 μm both inclusive. This makes it possible for a sufficient amount of lithium to be extracted from and inserted into the lithium metal layer 1X in an ionic state, thus helping to achieve higher effects.

In an embodiment, the inorganic solid electrolyte layer 2 may include lithium, oxygen, and the characteristic element (phosphorus) as constituent elements, and the content of lithium in the inorganic solid electrolyte layer 2 may be within the range from 10 at % to 60 at % both inclusive. This makes it easier for the inorganic solid electrolyte layer 2 to serve sufficiently as the protective film and the source of lithium, thus helping to achieve higher effects.

In an embodiment, the thickness T3 of the inorganic solid electrolyte layer 2 may be within the range from 10 nm to 20,000 nm both inclusive. This makes it easier for the inorganic solid electrolyte layer 2 to serve sufficiently as the protective film and the source of lithium, thus helping to achieve higher effects.

The active material layer 1 is formed by rolling the precursor 3 (the lithium metal layer 1X, the intermediate layer 1Y, and the surface layer 1Z) in the reduced-pressure environment or the inert gas atmosphere, following which the inorganic solid electrolyte layer 2 is formed on the surface layer 1Z of the active material layer 1.

Accordingly, as described above, because the thickness T2 of the surface layer 1Z is reduced using the rolling process of the precursor 3, the high-resistance component such as lithium carbonate included in the surface layer 1Z is removed. This decreases the interface resistance R, thus helping to achieve the negative electrode 100 having a superior electrical characteristic.

In this case, in order to manufacture the negative electrode 100, only simple processes are used that include the rolling process of the precursor 3 and a forming process of the inorganic solid electrolyte layer 2. Thus, a complicated process such as an acid solution treatment of the lithium metal foil or an etching process of the lithium metal foil is not to be used. This helps to easily obtain the negative electrode 100 having a superior electrical characteristic.

In an embodiment, after the active material layer 1 is formed in the reduced-pressure environment or the inert gas atmosphere, the inorganic solid electrolyte layer 2 may be successively formed in the same environment without exposing the active material layer 1 to the atmosphere. This suppresses the additional formation of the high-resistance component on the surface of the active material layer 1. Accordingly, the interface resistance R is further decreased, which helps to achieve higher effects.

In an embodiment, the precursor 3 may be disposed between the pair of protective films 4 (polyolefin) in the reduced-pressure environment or the inert gas atmosphere, following which the precursor 3 may be pressed through the pair of protective films 4 in the same environment. This suppresses deterioration (alteration and discoloration) of the precursor 3 during the rolling process. Accordingly, the interface resistance R is further decreased, which helps to achieve higher effects.

In an embodiment, in the result of the element analysis of the outermost surface of the surface layer 1Z based on XPS after the formation of the active material layer 1 and before the formation of the inorganic solid electrolyte layer 2, the abundance ML may be greater than each of the abundances MO and MC. This reduces the abundance of the high-resistance component at the interface between the active material layer 1 and the inorganic solid electrolyte layer 2. Accordingly, the interface resistance R is sufficiently decreased, which helps to achieve higher effects.

In an embodiment, the pressure in the reduced-pressure environment may be 1×10⁻¹ Pa or less. This prevents the high-resistance component from being easily formed newly on the surface of the precursor 3 during the rolling process. This helps to achieve higher effects. In an embodiment, the inert gas atmosphere may include the argon gas, and the oxygen concentration in the inert gas atmosphere may be 0.2 ppm or less. This prevents the high-resistance component from being easily formed newly on the surface of the precursor 3 during the rolling process. This helps to achieve higher effects.

In an embodiment, the inorganic solid electrolyte layer 2 may be formed using the vapor phase film forming method. This makes it easier for the inorganic solid electrolyte layer 2 to be formed stably and reproducibly while suppressing the additional formation of the high-resistance component on the surface of the active material layer 1. This helps to achieve higher effects.

Next, a battery according to an embodiment of the present disclosure will be described as an example of an electrochemical device including the above-described negative electrode.

The battery described here includes a positive electrode and the negative electrode. As described above, the battery may be a primary battery or a secondary battery.

FIG. 8 illustrates a sectional configuration of a battery 200. Note that FIG. 8 illustrates only a part, of the battery 200, to be involved in a battery reaction (an electrode reaction).

As illustrated in FIG. 8, the battery 200 includes a positive electrode 10, a negative electrode 20, and an electrolyte 30. A kind of the battery 200 described here (a principle of the battery reaction) is not particularly limited. The battery 200 may thus be a lithium battery, a lithium-sulfur battery, or a lithium-air battery.

The positive electrode 10 is opposed to the negative electrode 20 with the electrolyte 30 interposed therebetween. A configuration of the positive electrode 10 varies depending on the kind of battery.

When the battery 200 is a lithium battery, the positive electrode 10 includes any one or more of lithium-containing compounds as one or more positive electrode active materials. The lithium-containing compound is a compound including one or more transition metal elements together with lithium as constituent elements, and is, for example, a compound such as an oxide, a phosphoric acid compound, a silicic acid compound, or a boric acid compound. Non-limiting examples of the oxide include LiNiO₂, LiCoO₂, LiMn₂O₄, LiNi_{0.33}Co_{0.33}Mn_{0.33}O₂, LiNi_{0.8}Co_{0.15}Al_{0.05}O₂, and Li₄Ti₅O₁₂. Non-limiting examples of the phosphoric acid compound include LiFePO₄ and LiMnPO₄.

In this case, in an embodiment, the positive electrode 10 may include a positive electrode current collector and a positive electrode active material layer, which are not illustrated. The positive electrode active material layer may include the one or more positive electrode active materials. The positive electrode current collector includes an electrically conductive material such as a metal material. The positive electrode active material layer is provided on the positive electrode current collector. In an embodiment, the positive electrode active material layer may further include any one or more of other materials including, without limitation, a positive electrode binder and a positive electrode conductor.

When the battery 200 is a lithium-sulfur battery, the positive electrode 10 includes any one or more of sulfur and sulfur compounds as the one or more positive electrode active materials. Non-limiting examples of the sulfur compounds include lithium sulfide and sulfur-containing polyacrylonitrile (PAN-S).

When the battery 200 is a lithium-air battery, the positive electrode 10 includes air as the positive electrode active material.

The negative electrode 20 has a configuration similar to that of the above-described negative electrode 100. The negative electrode 20 is so disposed that the inorganic solid electrolyte layer 2 is opposed to the positive electrode 10 with the electrolyte 30 interposed therebetween.

The electrolyte 30 is a medium that allows lithium to move in an ionic state between the positive electrode 10 and the negative electrode 20. The electrolyte 30 may be an electrolyte in liquid form (an electrolytic solution) or an electrolyte in solid form (a solid electrolyte) depending on the kind of battery.

In an embodiment where the electrolyte 30 is an electrolytic solution, a non-illustrated separator may be impregnated with the electrolytic solution. The electrolytic solution includes a solvent and an electrolyte salt. The solvent may be an aqueous solvent or a non-aqueous solvent (an organic solvent). The electrolyte salt includes a light metal salt such as a lithium salt. The separator is an insulating porous film interposed between the positive electrode 10 and the negative electrode 20, and includes a polymer compound.

Note that the battery 200 may be an all-solid-state battery that does not include an electrolytic solution. In this case, in an embodiment, the electrolyte 30 may be omitted. One reason for this is that the inorganic solid electrolyte layer 2 also serves as the electrolyte 30, allowing the electrolyte 30 to be not necessarily provided.

In an embodiment, the battery 200 may further include any one or more of other non-illustrated components. Non-limiting examples of the other components include an outer package member, a positive electrode lead, and a negative electrode lead.

The outer package member is a member that contains the positive electrode 10, the negative electrode 20, and the electrolyte 30. For example, the outer package member may be a battery can or a pouch-shaped film. The positive electrode lead is coupled to the positive electrode 10, and the negative electrode lead is coupled to the negative electrode 20.

In the battery 200, during the battery reaction (during the electrode reaction), lithium is extracted from the negative electrode 20 in an ionic state, and the extracted lithium is inserted into the negative electrode 20 in an ionic state.

According to the battery 200, the battery 200 includes the negative electrode 20. The negative electrode 20 has a configuration similar to that of the above-described negative electrode 100. This helps to achieve a superior electrical characteristic for the reasons described above, and thus helps to obtain a high battery capacity and a superior characteristic such as a superior cyclability characteristic.

Other action and example effects related to the battery 200 are similar to the action and example effects related to the negative electrode 100 described above.

Applications (application examples) of the battery 200 are not particularly limited. The battery 200 used as a power source may serve as a main power source or an auxiliary power source in, for example but not limited to, electronic equipment and an electric vehicle. The main power source is preferentially used regardless of the presence of any other power source. The auxiliary power source may be used in place of the main power source, or may be switched from the main power source.

Non-limiting examples of the applications of the battery 200 include: electronic equipment; apparatuses for data storage; electric power tools; battery packs to be mounted on, for example but not limited to, electronic equipment; medical electronic equipment; electric vehicles; electric power storage systems; and any other application to which the battery 200 is applicable. Non-limiting examples of the electronic equipment include video cameras, digital still cameras, mobile phones, laptop personal computers, headphone stereos, portable radios, portable information terminals, and any other electronic equipment to which the battery 200 is applicable. Non-limiting examples of the apparatuses for data storage include backup power sources, memory cards, and any other apparatus for data storage to which the battery 200 is applicable. Non-limiting examples of the electric power tools include electric drills, electric saws, and any other electric power tool to which the battery 200 is applicable. Non-limiting examples of the medical electronic equipment include pacemakers, hearing aids, and any other medical electronic equipment to which the battery 200 is applicable. Non-limiting examples of the electric vehicles include electric automobiles including hybrid automobiles, and any other vehicle to which the battery 200 is applicable. Non-limiting examples of the electric power storage systems include battery systems for home use or industrial use in which electric power is accumulated for a situation such as emergency, and any other electric power storage system to which the battery 200 is applicable. In an embodiment, the above-described applications may each use one battery 200. In an embodiment, the above-described applications may each use multiple batteries 200.

In an embodiment, the battery packs may each include a single battery. In an embodiment, the battery packs may each include an assembled battery. The electric vehicle is a vehicle that travels with the battery as a driving power source, and may be a hybrid automobile that is additionally provided with a driving source other than the battery. In the electric power storage system for home use, electric power accumulated in the battery serving as an electric power storage source may be utilized for using, for example but not limited to, home appliances.

### EXAMPLES

A description is given of Examples of an embodiment of the present disclosure.

### Example 1 and Comparative Example 1

The negative electrode 100 was fabricated, following which the negative electrode 100 was evaluated for a characteristic as described below.

### Fabrication of Negative Electrode

The negative electrode 100 illustrated in FIG. 1 was fabricated by the procedure illustrated in FIGS. 3 to 7.

First, the precursor 3 (the lithium ingot having a thickness of 1 mm) was prepared. As illustrated in FIG. 6, the precursor 3 included the lithium metal layer 1X (the thickness T1), the intermediate layer 1Y, and the surface layer 1Z.

Thereafter, the precursor 3 was placed between the pair of protective films 4 (two polypropylene films each having a thickness of 0.15 mm) inside the glove box (the inert gas atmosphere), following which the precursor 3 was lightly crushed by pressing the precursor 3 through the protective films 4 using a pestle. In this case, an argon gas was supplied to the inside of the glove box, whereby an oxygen concentration inside the glove box was set to 0.2 ppm or less.

Thereafter, the precursor 3 was rolled by pressing the precursor 3 through the pair of protective films 4 using the roll pressing machine equipped with the pair of rollers 5. In this case, the thickness of the precursor 3 after the rolling was made 0.1 mm by gradually decreasing a distance (a gap) between the pair of rollers 5 from 1 mm to 0.1 mm.

Thereafter, the precursor 3 after the rolling was folded multiple times, following which the precursor 3 was rolled again until the thickness of the precursor 3 reached 0.1 mm. In this case, the rolling process of the precursor 3 was repeated three times. As a result, the precursor 3 was stretched, and thus the active material layer 1 including the lithium metal layer 1X, the intermediate layer 1Y, and the surface layer 1Z was formed.

Thereafter, the inorganic solid electrolyte layer 2 was formed by depositing the inorganic solid electrolyte material (amorphous Li₃PO₄) on the surface layer 1Z of the active material layer 1 using the sputtering method inside a vacuum RF sputtering device (the inert gas atmosphere).

In this case, after the active material layer 1 was formed, the active material layer 1 was moved from an inside of the glove box to an inside of the vacuum RF sputtering device without being exposed to the atmosphere, and a pressure inside the vacuum RF sputtering device was set to 6.0×10⁻⁶ Pa.

Further, when the inorganic solid electrolyte layer 2 was formed, an argon gas was supplied to the inside of the vacuum RF sputtering device to cause the pressure to become 0.15 Pa, and a plate of Li₃PO₄ (having a diameter of 50.8 mm) was used as a target. In this case, power was 100 W.

As a result, the inorganic solid electrolyte layer 2 was formed on the active material layer 1 (the lithium metal layer 1X, the intermediate layer 1Y, and the surface layer 1Z), and thus the negative electrode 100 was completed (Example 1).

Note that, for comparison, the negative electrode was fabricated by a similar procedure except that the rolling process of the precursor 3 was not performed (Comparative example 1). In this case, a lithium metal foil stored in the atmosphere (a dry environment having a dew point temperature of 40° C. or lower) for three months was used as an active material layer. The active material layer included the lithium metal layer 1X, the intermediate layer 1Y, and the surface layer 1Z similarly to the active material layer 1 described above.

### Evaluation of Characteristic of Negative Electrode

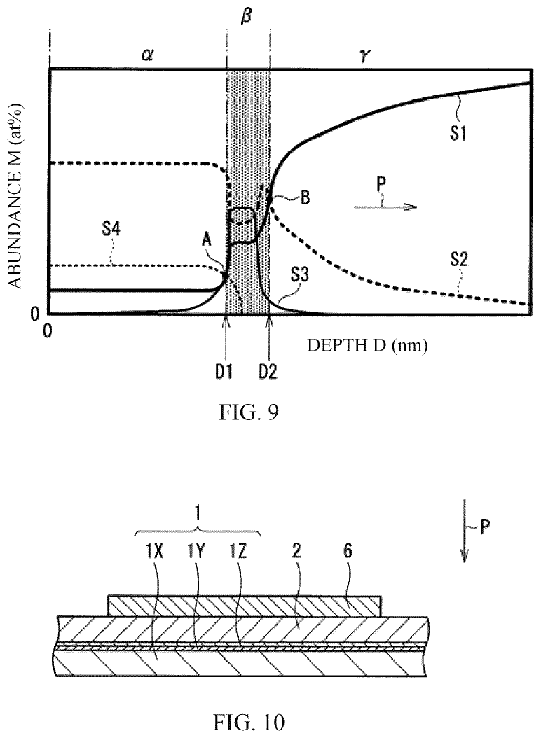

Evaluation of the electrical characteristic of the negative electrode by a procedure described below revealed the results presented in Tables 1 and 2 and FIGS. 2 and 9.

### Element Analysis of Outermost Surface of Surface Layer Based on XPS

After the formation of the active material layer 1 and before the formation of the inorganic solid electrolyte layer 2, the element analysis of the outermost surface of the surface layer 1Z was performed based on XPS by the procedure described above to calculate each of the abundances ML, MO, and MC (at %). Accordingly, the results presented in Table 1 were obtained.

### Element Analysis of Negative Electrode in Depth Direction Based on XPS

After the negative electrode was completed, the element analysis of the negative electrode in the depth direction P was performed based on XPS by the procedure described above. Accordingly, the results illustrated in FIGS. 2 and 9 were obtained.

FIG. 2 schematically illustrates the result of the element analysis for Example 1 as described above. FIG. 9 schematically illustrates a result of the element analysis for Comparative example 1 and corresponds to FIG. 2. Note that in FIG. 9, each of the points C and D and the depth D3 is not illustrated because each of the thickness T2 of the surface layer 1Z and the thickness of the intermediate layer 1Y was large.

As illustrated in each of FIGS. 2 and 9, the result of the element analysis of the negative electrode in the depth direction P based on XPS included detection of the lithium spectrum S1, the oxygen spectrum S2, the carbon spectrum S3, and the phosphorus spectrum S4. As a result, the intermediate layer 1Y included lithium and oxygen as constituent elements. The surface layer 1Z included lithium, oxygen, and carbon as constituent elements. The inorganic solid electrolyte layer 2 included lithium, oxygen, and the characteristic element (phosphorus) as constituent elements.

### Abundance Ratios Z1 and Z2

Each of the abundances ML and MC (at %) was identified based on the result of the element analysis of the negative electrode in the depth direction P illustrated in each of FIGS. 2 and 9 by the procedure described above, following which the abundance ratio Z1 was calculated. Accordingly, the results presented in Table 2 were obtained.

In addition, each of the abundances MO and MC (at %) was identified based on the result of the element analysis of the negative electrode in the depth direction P illustrated in each of FIGS. 2 and 9 by the procedure described above, following which the abundance ratio Z2 was calculated. Accordingly, the results presented in Table 2 were obtained.

### Thickness T2

The thickness T2 (nm) was identified based on the result of the element analysis of the negative electrode in the depth direction P (each of FIGS. 2 and 9) by the procedure described above. Accordingly, the results presented in Table 2 were obtained.

### Interface Resistance R

In order to find out an electric resistance characteristic of the negative electrode as the electrical characteristic of the negative electrode, the interface resistance R (Ω·cm²) of the negative electrode was calculated. Accordingly, the results presented in Table 2 were obtained.

FIG. 10 illustrates a sectional configuration corresponding to FIG. 1 for describing a method of measuring the interface resistance R. In measuring the interface resistance R, a measurement electrode 6 was formed on the inorganic solid electrolyte layer 2 as illustrated in FIG. 10, following which an alternating-current impedance (an amplitude voltage of 50 mV) of the negative electrode was measured using the measurement electrode 6 together with a non-illustrated pair of resistance measurement probes.

In forming the measurement electrode 6, after the fabrication of the negative electrode, the negative electrode was moved from the inside of the vacuum RF sputtering device to an inside of a vacuum deposition device without being exposed to the atmosphere, and a pressure inside the vacuum deposition device was decreased to reach 1.0×10⁻⁶ Pa. Thereafter, the measurement electrode 6 (having a diameter of 0.5 mm) was formed by depositing lithium metal on the surface of the inorganic solid electrolyte layer 2 using a vacuum deposition method.

In measuring the interface resistance R, one of the probes was coupled to the lithium metal layer 1X, and another of the probes was coupled to the measurement electrode 6. In addition, a Cole-Cole plot was obtained based on a measurement result of the alternating-current impedance, following which the interface resistance R was calculated based on the Cole-Cole plot.

TABLE 1

| | Abundance ML | Abundance MO | Abundance MC |
|---|---|---|---|
| | (at %) | (at %) | (at %) |
| Example 1 | 39.6 | 28.6 | 31.2 |
| Comparative | 24.4 | 34.9 | 39.1 |
| example 1 | | | |

TABLE 2

| | | | | Interface |
|---|---|---|---|---|
| | Thickness T2 | Abundance | Abundance | resistanec R |
| | (nm) | ratio Z1 | ratio Z2 | (Ω · cm²) |
| Example 1 | 70 | 5.6 | 5.6 | 80 |
| Comparative | >300 | 0.58 | 0.90 | 500 |
| example 1 | | | | |

As presented in Tables 1 and 2, the electrical characteristic of the negative electrode varied greatly depending on the configuration and the physical property of the negative electrode.

When the rolling process of the precursor 3 was not performed (Comparative example 1), the interface resistance R increased to 500 Ω·cm². In contrast, when the rolling process of the precursor 3 was performed (Example 1), the interface resistance R decreased to 80 Ω·cm².

As a result, an electric resistance of the entire negative electrode 100 when the rolling process of the precursor 3 was performed was about ⅓ of the electric resistance of the entire negative electrode when the rolling process of the precursor 3 was not performed. Thus, fabricating the battery 200 using the negative electrode 100 that has been subjected to the rolling process of the precursor 3 made it possible to charge or discharge the battery 200 at a current value of about three times that of a case in which the battery 200 was fabricated using the negative electrode that has not been subjected to the rolling process of the precursor 3.

Note that when the rolling process of the precursor 3 was not performed (Comparative example 1), the thickness T2 was greater than 300 nm. In contrast, when the rolling process of the precursor 3 was performed (Example 1), the thickness T2 was 70 nm, which was within the range of 100 nm or less.

In addition, when the rolling process of the precursor 3 was not performed (Comparative example 1), the abundance ML was smaller than each of the abundances MO and MC at a point in time when the active material layer 1 was formed. In contrast, when the rolling process of the precursor 3 was performed (Example 1), the abundance ML was greater than each of the abundances MO and MC at a point in time when the active material layer 1 was formed.

Further, when the rolling process of the precursor 3 was not performed (Comparative example 1), the abundance ratio Z1 was 2 or less, and the abundance ratio Z2 was 3 or less at any depth D within the range of the surface layer 1Z. The interface resistance R was thus increased. In contrast, when the rolling process of the precursor 3 was performed (Example 1), the abundance ratio Z1 was greater than 2 and the abundance ratio Z2 was greater than 3 at any depth D within the range of the surface layer 1Z. The interface resistance R was thus decreased.

The results presented in Tables 1 and 2 and FIGS. 2 and 9 demonstrated that the interface resistance R was decreased when: the negative electrode included the active material layer 1 (the lithium metal layer 1X, the intermediate layer 1Y, and the surface layer 1Z) and the inorganic solid electrolyte layer 2; the intermediate layer 1Y included lithium and oxygen as constituent elements; the surface layer 1Z included lithium, oxygen, and carbon as constituent elements; the inorganic solid electrolyte layer 2 included the characteristic element; and the abundance ratio Z1 was greater than 2 at any depth D within the range of the surface layer 1Z. This made it possible for the negative electrode to have a superior electrical characteristic (electric resistance characteristic).

In addition, the procedure of manufacturing the negative electrode 100 using the rolling process of the precursor 3 made it possible to achieve the negative electrode 100 having a superior electrical characteristic (electric resistance characteristic).

Although the present disclosure has been described above with reference to an embodiment and Example, a configuration of an embodiment of the present disclosure is not limited to those described with reference to the embodiments including Example above, and is therefore modifiable in a variety of ways.

For example, although a case where the characteristic element included in the inorganic solid electrolyte layer is phosphorus has been described, the kind of the characteristic element is not particularly limited, and therefore, an element other than phosphorus may be used. Example details of the characteristic elements other than phosphorus are as described above.

The effects described herein are mere examples, and effects of an embodiment of the present disclosure are therefore not limited to those described herein. Accordingly, the present disclosure may achieve any other effect.

Furthermore, the present disclosure encompasses any possible combination of some or all of the various embodiments and the modification examples described herein and incorporated herein. It is possible to achieve at least the following configurations from the above-described embodiments of the present disclosure.

(1)

A negative electrode including:
an active material layer; and
an inorganic solid electrolyte layer provided on the active material layer, in which
the active material layer includes, in order from a side far from the inorganic solid electrolyte layer,
   a lithium metal layer,
   an intermediate layer including lithium and oxygen as constituent elements, and
   a surface layer including lithium, oxygen, and carbon as constituent elements,
the inorganic solid electrolyte layer includes, as a constituent element, a characteristic element different from lithium, oxygen, and carbon, and
in a result of an element analysis of the active material layer and the inorganic solid electrolyte layer in a depth direction based on X-ray photoelectron spectroscopy, a ratio of an abundance of lithium to an abundance of carbon is greater than 2 at any depth within a range from a first intersection to a second intersection, the first intersection being where a spectrum derived from the characteristic element and a spectrum derived from carbon intersect each other, the second intersection being where a spectrum derived from lithium and a spectrum derived from oxygen intersect each other.
   (2)

The negative electrode according to (1), in which, in the result of the element analysis of the active material layer and the inorganic solid electrolyte layer in the depth direction based on the X-ray photoelectron spectroscopy, a ratio of an abundance of oxygen to the abundance of carbon is greater than 3 at any depth within the range from the first intersection to the second intersection.

(3)

The negative electrode according to (1) or (2), in which the surface layer has a thickness of 100 nanometers or less.

(4)

The negative electrode according to any one of (1) to (3), in which the lithium metal layer has a thickness of greater than or equal to 10 micrometers and less than or equal to 1000 micrometers.

(5)

The negative electrode according to any one of (1) to (4), in which
the inorganic solid electrolyte layer includes lithium, oxygen, and the characteristic element as constituent elements, the characteristic element including phosphorus, and
a content of lithium in the inorganic solid electrolyte layer is greater than or equal to 10 atomic percent and less than or equal to 60 atomic percent.
   (6)

The negative electrode according to any one of (1) to (5), in which the inorganic solid electrolyte layer has a thickness of greater than or equal to 10 nanometers and less than or equal to 20,000 nanometers.

(7)

A method of manufacturing a negative electrode, the method including:
preparing a precursor in which a lithium metal layer, an intermediate layer, and a surface layer are stacked in this order, the intermediate layer including lithium and oxygen as constituent elements, the surface layer including lithium, oxygen, and carbon as constituent elements;
forming an active material layer including the lithium metal layer, the intermediate layer, and the surface layer by subjecting the precursor to rolling in a reduced-pressure environment or an inert gas atmosphere; and
forming an inorganic solid electrolyte layer on the surface layer of the active material layer in the reduced-pressure environment or the inert gas atmosphere.
   (8)

The method of manufacturing the negative electrode according to (7), in which, the forming of the inorganic solid electrolyte layer includes, after the forming of the active material layer in the reduced-pressure environment or the inert gas atmosphere, successively forming the inorganic solid electrolyte layer in the reduced-pressure environment or the inert gas atmosphere without exposing the active material layer to atmosphere.

(9)

The method of manufacturing the negative electrode according to (7) or (8), in which
the rolling of the precursor includes disposing the precursor between a pair of protective members in the reduced-pressure environment or the inert gas atmosphere, and pressing, after the disposing of the precursor, the precursor through the pair of protective members in a direction in which the protective members are opposed to each other, and
each of the protective members includes polyolefin.
   (10)

The method of manufacturing the negative electrode according to any one of (7) to (9), in which, in a result of an element analysis of an outermost surface of the surface layer based on X-ray photoelectron spectroscopy after the forming of the active material layer and before the forming of the inorganic solid electrolyte layer, an abundance of lithium is greater than each of an abundance of oxygen and an abundance of carbon.

(11)

The method of manufacturing the negative electrode according to any one of (7) to (10), in which
the reduced-pressure environment has a pressure of 1×10⁻¹ pascals or less, and
the inert gas atmosphere includes an argon gas and has an oxygen concentration of 0.2 parts per million or less.
   (12)

The method of manufacturing the negative electrode according to any one of (7) to (11), in which the forming of the inorganic solid electrolyte layer includes performing a vapor phase film forming method.

(13)

A battery including:
a positive electrode; and
the negative electrode according to any one of (1) to (6).

According to a negative electrode an embodiment of the present disclosure, the negative electrode includes an active material layer (a lithium metal layer, an intermediate layer, and a surface layer) and an inorganic solid electrolyte layer. The intermediate layer includes lithium and oxygen as constituent elements. The surface layer includes lithium, oxygen, and carbon as constituent elements. The inorganic solid electrolyte layer includes, as a constituent element, a characteristic element different from lithium, oxygen, and carbon. In addition, in a result of an element analysis of the active material layer and the inorganic solid electrolyte layer in a depth direction based on X-ray photoelectron spectroscopy, a ratio of an abundance of lithium to an abundance of carbon is greater than 2 at any depth within a range from a first intersection to a second intersection. This makes it possible to achieve a superior electrical characteristic.

According to a method of manufacturing a negative electrode of an embodiment of the present disclosure, a precursor including a lithium metal layer, an intermediate layer, and a surface layer is prepared. The intermediate layer includes lithium and oxygen as constituent elements. The surface layer includes lithium, carbon, and oxygen as constituent elements. The precursor is subjected to rolling in a reduced-pressure environment or an inert gas atmosphere to thereby form an active material layer including the lithium metal layer, the intermediate layer, and the surface layer. An inorganic solid electrolyte layer is formed on the surface layer of the active material layer in the reduced-pressure environment or the inert gas atmosphere. This makes it possible to achieve a negative electrode having a superior electrical characteristic.

According to a battery of an embodiment of the present disclosure, the battery includes a positive electrode and a negative electrode, and the negative electrode has any of the configurations described above. This makes it possible to achieve a superior electrical characteristic.

Note that effects of an embodiment of the present disclosure are not necessarily limited to those described herein and may include any of a series of effects including described below in relation to the present disclosure.

Although the present disclosure has been described hereinabove in terms of an embodiment including modification examples, the present disclosure is not limited thereto. It should be appreciated that variations may be made in the described embodiments including modification examples by those skilled in the art without departing from the scope of the present disclosure.

The limitations in the claims are to be interpreted broadly based on the language employed in the claims and not limited to examples described in this specification or during the prosecution of the application, and the examples are to be construed as non-exclusive. As used in this specification and the appended claims, the singular forms “a,” “an,” and “the” include, especially in the context of the claims, are to be construed to cover both the singular and the plural, unless otherwise indicated herein or clearly contradicted by context. Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step. The use of the terms first, second, etc. do not denote any order or importance, but rather the terms first, second, etc. are used to distinguish one element from another. The term “substantially”, “approximately”, “about”, and its variants having the similar meaning thereto are defined as being largely but not necessarily wholly what is specified as understood by one of ordinary skill in the art. The term “disposed on/provided on/formed on” and its variants having the similar meaning thereto as used herein refer to elements disposed directly in contact with each other or indirectly by having intervening structures therebetween.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A negative electrode comprising:
an active material layer; and
an inorganic solid electrolyte layer provided on the active material layer, wherein
the active material layer includes, in order from a side far from the inorganic solid electrolyte layer,
a lithium metal layer,
an intermediate layer including lithium and oxygen as constituent elements, and
a surface layer including lithium, oxygen, and carbon as constituent elements,
the inorganic solid electrolyte layer includes, as a constituent element, a characteristic element different from lithium, oxygen, and carbon, and
in a result of an element analysis of the active material layer and the inorganic solid electrolyte layer in a depth direction based on X-ray photoelectron spectroscopy, a ratio of an abundance of lithium to an abundance of carbon is greater than 2 at any depth within a range from a first intersection to a second intersection, the first intersection being where a spectrum derived from the characteristic element and a spectrum derived from carbon intersect each other, the second intersection being where a spectrum derived from lithium and a spectrum derived from oxygen intersect each other.

2. The negative electrode according to claim 1, wherein, in the result of the element analysis of the active material layer and the inorganic solid electrolyte layer in the depth direction based on the X-ray photoelectron spectroscopy, a ratio of an abundance of oxygen to the abundance of carbon is greater than 3 at any depth within the range from the first intersection to the second intersection.

3. The negative electrode according to claim 1, wherein the surface layer has a thickness of 100 nanometers or less.

4. The negative electrode according to claim 1, wherein the lithium metal layer has a thickness of greater than or equal to 10 micrometers and less than or equal to 1000 micrometers.

5. The negative electrode according to claim 1, wherein
the inorganic solid electrolyte layer includes lithium, oxygen, and the characteristic element as constituent elements, the characteristic element comprising phosphorus, and
a content of lithium in the inorganic solid electrolyte layer is greater than or equal to 10 atomic percent and less than or equal to 60 atomic percent.

6. The negative electrode according to claim 1, wherein the inorganic solid electrolyte layer has a thickness of greater than or equal to 10 nanometers and less than or equal to 20,000 nanometers.

7. A method of manufacturing a negative electrode, the method comprising:
preparing a precursor in which a lithium metal layer, an intermediate layer, and a surface layer are stacked in this order, the intermediate layer including lithium and oxygen as constituent elements, the surface layer including lithium, oxygen, and carbon as constituent elements;
forming an active material layer including the lithium metal layer, the intermediate layer, and the surface layer by subjecting the precursor to rolling in a reduced-pressure environment or an inert gas atmosphere; and
forming an inorganic solid electrolyte layer on the surface layer of the active material layer in the reduced-pressure environment or the inert gas atmosphere.

8. The method of manufacturing the negative electrode according to claim 7, wherein the forming of the inorganic solid electrolyte layer comprises, after the forming of the active material layer in the reduced-pressure environment or the inert gas atmosphere, successively forming the inorganic solid electrolyte layer in the reduced-pressure environment or the inert gas atmosphere without exposing the active material layer to atmosphere.

9. The method of manufacturing the negative electrode according to claim 7, wherein
the rolling of the precursor comprises disposing the precursor between a pair of protective members in the reduced-pressure environment or the inert gas atmosphere, and pressing, after the disposing of the precursor, the precursor through the pair of protective members in a direction in which the protective members are opposed to each other, and
each of the protective members includes polyolefin.

10. The method of manufacturing the negative electrode according to claim 7, wherein, in a result of an element analysis of an outermost surface of the surface layer based on X-ray photoelectron spectroscopy after the forming of the active material layer and before the forming of the inorganic solid electrolyte layer, an abundance of lithium is greater than each of an abundance of oxygen and an abundance of carbon.

11. The method of manufacturing the negative electrode according to claim 7, wherein
the reduced-pressure environment has a pressure of 1×10⁻¹ pascals or less, and
the inert gas atmosphere includes an argon gas and has an oxygen concentration of 0.2 parts per million or less.

12. The method of manufacturing the negative electrode according to claim 7, wherein the forming of the inorganic solid electrolyte layer comprises performing a vapor phase film forming method.

13. A battery comprising:
a positive electrode; and
a negative electrode including
an active material layer, and
an inorganic solid electrolyte layer provided on the active material layer, wherein
the active material layer includes, in order from a side far from the inorganic solid electrolyte layer,
a lithium metal layer,
an intermediate layer including lithium and oxygen as constituent elements, and
a surface layer including lithium, oxygen, and carbon as constituent elements,
the inorganic solid electrolyte layer includes, as a constituent element, a characteristic element different from lithium, oxygen, and carbon, and
in a result of an element analysis of the active material layer and the inorganic solid electrolyte layer in a depth direction based on X-ray photoelectron spectroscopy, a ratio of an abundance of lithium to an abundance of carbon is greater than 2 at any depth within a range from a first intersection to a second intersection, the first intersection being where a spectrum derived from the characteristic element and a spectrum derived from carbon intersect each other, the second intersection being where a spectrum derived from lithium and a spectrum derived from oxygen intersect each other.
